(19) United States
(12) Patent Application Publication
(10) Pub. No.: US 2008/0208664 A1
(43) Pub. Date: Aug. 28, 2008

(54) OPTIMIZATION OF CLASS SCHEDULING UNDER DEMAND UNCERTAINTY

(76) Inventors: Gyana Ranjan PARIJA, Poughkeepsie, NY (US); David Jonrowe Davidson, Marietta, GA (US); Samir Sharma, Mohegan Lake, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 12/114,885

(22) Filed: May 5, 2008

Related U.S. Application Data
(63) Continuation of application No. 10/714,620, filed on Nov. 18, 2003.

(51) Int. Cl. G06F 17/50

(52) U.S. Cl. 705/7

(57) ABSTRACT

A stochastic integer programming based constrained optimization technique enables optimal allocation of classrooms and instructors to requested classes associated with cancellation probabilities. An analytical tool allows optimization of overall operational revenue/profit under different planning scenarios involving chaining of various classes, prerequisite relationships, and inter-class spacing requirements. This system allows the description and input of a list of classes, their cancellation probabilities and the input of available classrooms and instructors for determining the most revenue-generating/profitable class schedule. The revenue/profit optimization model corresponds to a two-stage mixed integer program.

### BACKGROUND OF THE INVENTION

1. Field of the Invention

The present invention generally relates to optimized scheduling of classes in educational institutions and, more particularly, to a method for determining a best schedule of classes and allocation of instructors and classrooms to the scheduled classes.

2. Background Description

Educational institutions are faced with the perennial problem of determining schedules of classes. This problem is not just one of allocating resources such as instructors, class rooms and the like, but a problem of predicting the demand for courses and the numbers of students who will enroll for those courses.

As a specific example, IBM Learning Services (ILS) offers about 700 public classes nationwide every quarter and in a dozen U.S. cities. These classes are taught either by IBM or one of its training partners (TP). The problem is to determine the best schedule for these class offerings and assignment of Education and Training (E&T) instructors and E&T classrooms to the ILS-offered classes. A robust schedule would have fewer chances of class cancellations, larger class sizes, and optimal utilization of classrooms. The determination of a good schedule is made by maximizing the revenue/profit associated with the schedule while allocating constrained resources (time, rooms, instructors) under demand uncertainty (class cancellations). Classes are scheduled using historical demand and cancellation patterns.

### SUMMARY OF THE INVENTION

It is therefore an object of the present invention to provide a method which enables optimal allocation of classrooms and instructors to requested classes.

According to the invention, there is provided an innovative, stochastic integer programming based constrained optimization technique upon which is built an analytical tool that enables optimal allocation of classrooms and instructors to requested classes associated with cancellation probabilities. This tool allows optimization of overall operational revenue/profit under different planning scenarios involving chaining of various classes, prerequisite relationships, and inter-class spacing requirements. This invention allows the description and input of a list of classes, their cancellation probabilities and the input of available classrooms and instructors for determining the most revenue-generating/profitable class schedule. The revenue/profit optimization model corresponds to a two-stage mixed integer program that can be resolved using any commercial off-the-shelf mixed integer programming (MIP) solver.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of the system architecture of the scheduling system according to a preferred embodiment of the invention;

FIG. 2 is a block diagram showing the data flow of the block scheduling system according the invention;

FIG. 3 is a diagram of a scenario tree for class realizations;

FIG. 4 is a flow diagram showing the process flow for block scheduling; and

FIG. 5 is a flow diagram showing the process of creation and solution of a robust block scheduling model.

### DETAILED DESCRIPTION OF A PREFERRED EMBODIMENT OF THE INVENTION

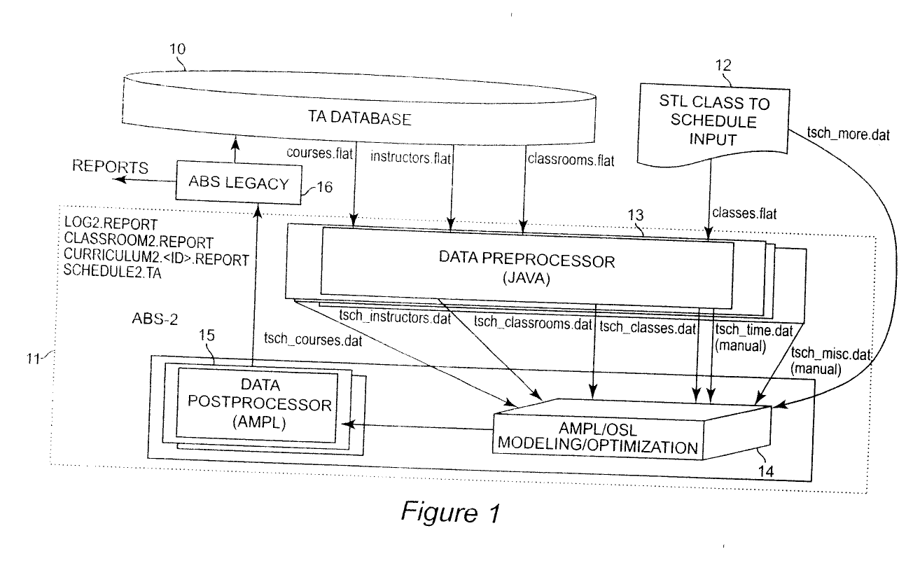

Referring now to the drawings, and more particularly to FIG. 1, there is shown the overall system architecture on which the invention may be implemented. The Training Administration (TA) database system is a database where the IBM Learning Services (ILS) keeps all their course, curriculum and schedule data. The Automatic Block Scheduling (ABS) application is the class scheduling application that ILS uses. The current version is referred to as “ABS Legacy”, while the new version that incorporates the features of the present invention is referred to as “ABS-2” or “Automated Block Scheduling Version 2”. The TA database system 10 is accessed on a batch basis, and the information necessary to describe the courses, instructors, and classrooms are extracted to flat files (“courses.flat”, “instructors.flat”, and “classrooms.flat”) and passed to the ABS-2 application implemented on data processing system 11. The STL's (scheduling team lead's) class to schedule input (“classes.flat”) 12 is also collected and passed to the ABS-2 application implemented on data processing system 11. In addition, another file (“tsch_more.dat”) containing the optional data items pertaining to chaining, precedence requirements, and resource conflicts for non-commodity resources are also input.

The data processor (a java application) 13 in the ABS-2 application implemented on data processing system 11 receives these files and builds data structures in flat files (“tsch_courses.dat”, “tsch_instructors.dat”, “tsch_classrooms.dat”, “tsch_classes.dat”, “tsch_time.dat”, and “tsch_misc.dat”) needed to build a mathematical programming model (an AMPL/OSL (A Mathematical Programming Language/Optimization Solutions and Library) application) 14 to support the generation of all the possible ways to offer each class. (OSL is IBM's library of high-performance optimization subroutines for linear, mixed integer and quadratic programming, supported on multiple hardware platforms, from PCs, to workstations, to supercomputers. This library includes Optimization Solutions and Library Stochastic Extensions (OSLSE) software.) The error checking is basic and usually results in a stopped run whenever the data is seriously incomplete or inconsistent. When the data structures (AMPL arrays and tables) are in place, the AMPL/OSL model code is executed to build all of the possible ways each class could be scheduled and to assign a cost to each decision. This cost takes the form of the revenue historically expected from each class less costs.

At the end of the optimization run, the solution data structure is updated with the date, instructor(s) and classroom(s) used by data postprocessor 15. This data structure is then accessed to produce a flat file (“schedule2.TA”) as input to a ABS legacy application 16 to batch update of the TA system and produce other necessary reports.

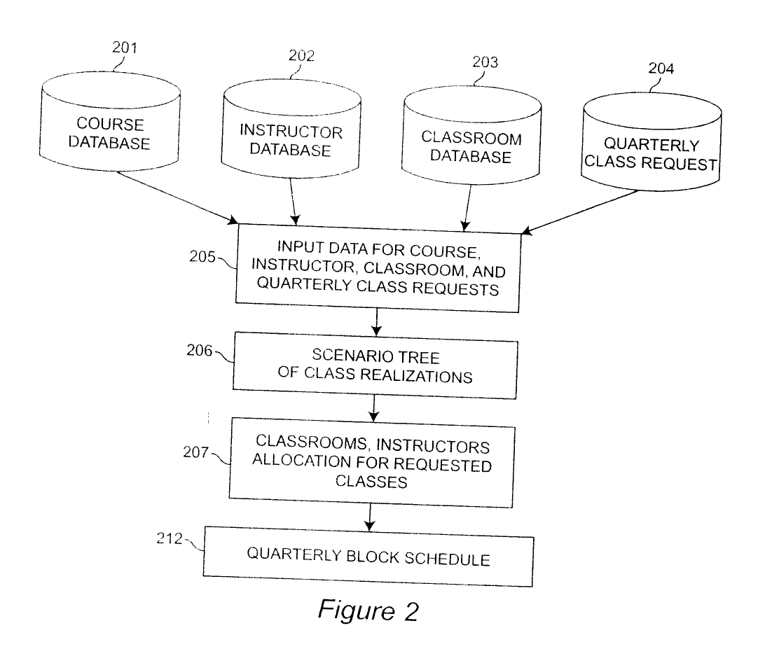

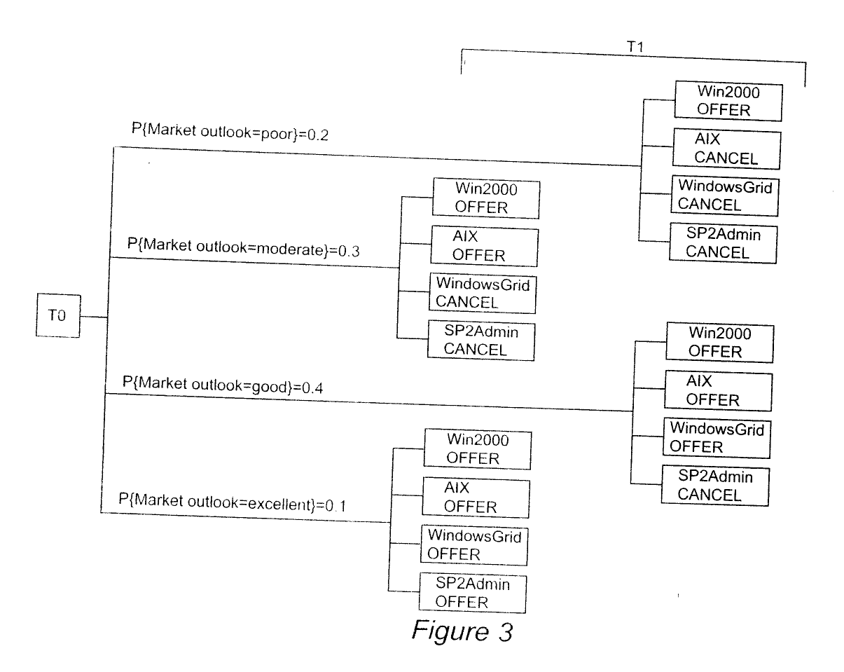

FIG. 2 shows the data flow of the block scheduling system. Conceptually, there are four databases; a course database 201, an instructor database 202, a classroom database 203, and a quarterly (or semester) class request database 204. Data from these four databases are input at 205, and a scenario tree of class realizations is generated at 206. An example of a scenario tree is shown in FIG. 3.

As shown in FIG. 3, a scenario is a sequence of events associated with realizations of random variables. For example, the stock price of a publicly traded company on any given day may be thought of as a “random variable”. The likely stock price on a particular day would then be an “event”. If we are constructing a scenario for planning purposes over the first quarter (or semester) of a year, then we have as many events in the scenario as the number of trading days in the quarter. Uncertainties in the outcome of an event can give rise to many possible realizations (e.g., stock price on September 19=$150, or stock price on September 19=$100) for an event. Thus, one may construct many unique scenarios as there are unique ways of combining the sequence of events during the planning horizon of trading days. Therefore, in this example, we may construct a scenario tree by describing all the scenarios on a planar graph using nodes and arcs joining the nodes. Each node of the tree is associated with a time period (stage) on the planning horizon and describes the history of a scenario leading up to that time stage. Each arc between any pair of nodes on this tree describes the predecessor-successor relationship between two consecutive events. The “root” node of such a scenario tree is at stage 1 by which no events have been realized. In our stock trading example, all the events corresponding to the first day of trading would correspond to “nodes” at stage 2. Each of these nodes is connected to the “root” node by an arc.

In FIG. 3, we consider a scenario tree as an example in the context of the block scheduling application. Node “T0” is the root node of the scenario tree where we seek to implement the optimal schedule. Nodes “T11”, “T12”, “T13”, and “T14” are four possible realizations of the class offering events for four courses; namely, Win2000, AIX, WindowsGrid, and SP2Admin. Each course has a likely outcome of “OFFER” or “CANCEL” for the specified time period. Thus, a combination of the node “T0” with each of the nodes “T11”, “T12”, “T13”, and “T14” creates a unique scenario. Each of the scenarios is associated with a probability that is estimated from historical cancellation patterns.

Returning to FIG. 2, the generated scenario tree of class realizations is used at 207 to produce an allocation of classrooms and instructors for requested classes. This allocation is then used to produce the quarterly (or semester) block schedule at 212.

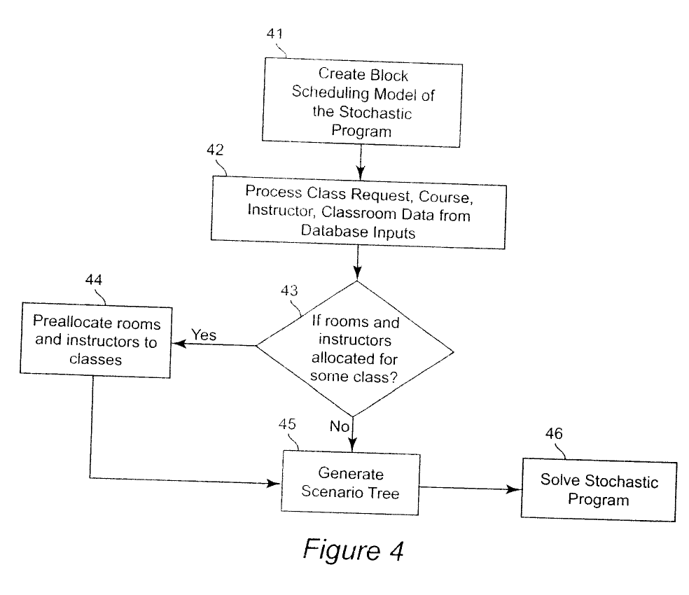

FIG. 4 shows the process flow for the block scheduling. The process begins by creating a block scheduling model of the stochastic program in function block 41. Ths is preformed by the programming model 14 shown in FIG. 1. This model is used to process class request, course, instructor, and classroom data from the several database inputs in function block 42. A determination is made in decision block 43 as to whether all rooms and instructors have been allocated for some class. If so, rooms and instructors are pre-allocated to classes in function block 44, and then the process goes to function block 45 where the scenario tree is generated. If the determination made in decision block 43 is negative, the process goes directly to function block 45 without the preallocation step. Once the scenario tree has been generated, the stochastic program is executed in function block 46.

### Resource Pre-Allocation Rules

The Resource Pre-allocation Rules implemented in the process of FIG. 4 are described below. First are the Rules successively applied to schedule the instructor:
IF the course is an Available Training Partner (ATP) course and the class will be held in the ATP territory, then the STL calls the ATP and offers the “first right of refusal” to the ATP.
IF the ATP accepts then:
Specify the ATP name in the INSTRUCTOR_TYPE field
Enter the class start date
Put an appropriate entry in the comment field regarding ATP name (Note: this class is now completely scheduled outside the block scheduling system)
ELSE Continue.
IF, in general, the course instructor has already been obtained from the non E&T instructors (i.e., Vendors or other IBM Service Engineers): Mark the Got_a_Instructor Flag
IF a particular E&T Instructor(s) is to be assigned to this class then: Enter the instructor's serial number in the Instructor Preference(s) field (this will cause this instructor or the “Missing” Instructor to be assigned to this class).
IF any E&T instructor is satisfactory then let the system: Assign an instructor from the E&T pool (Note: about 80% of the courses should be scheduled here).
IF there is no E&T instructor available then let the scheduling system: Assign a “Missing Instr”. A penalty cost of a globally specified percentage of revenue will be applied to this selection.

The Rules successively applied to schedule the classroom(s) are as follows:
IF the classroom(s) has been previously obtained either at a non E&T location or previously reserved with the TA system: Mark the Got_a_room flag.
ELSE if there exists an available classroom that satisfies the location, facility, tier level course requirement, and seating capacity requirements (either the historical or requested capacity if present), then the system will assign a classroom.
ELSE if no room is available then the scheduling system will assign a “Missing Room” classroom. A penalty cost of a globally specified percentage of revenue will be applied to this selection.
The System Definition Statements are as follows:
1. The planning duration is 1 quarter, 13 or 14 weeks.
2. The day input on the flat file will be a based on a 364 day year using Julian dates in the form (YYYYDDD).
3. The weeks will be supplied on the flat file by specifying the Julian date of the Monday of the week in consideration.
4. The courses with Course_rank=1 will be preferred and their instructors and dates will be preferentially assigned before those with Course_rank =2.
5. Classrooms and instructors can be indicated as non available on particular days. This allows classes that have been already scheduled, vacations or classroom tier level changes to be accounted for.

The Details regarding content and usage of the input flat files are as follows:

### Course:

The system rounds the “Course length in days” to the next higher day (i.e., 4.5 goes to 5.0).
Each course is associated with a set of usable tier codes, with each tier code corresponding to a level of resource requirement by the course.

### Instructor:

The serial number is a unique identification of a instructor.
Instructor Costs to teach a class will be calculated for E&T instructors only based on travel cost.
The instructor city field is used to determine the home teach location for that instructor.

### Classroom:

The City, Facility, and Room name should be unique.
The City name is compared to the Instructor city to determine when to apply travel costs to the selection of that instructor.
A penalty cost of a percentage of potential revenue will be charged for each class that is assigned to a “missing” or TBA (to be announced) classrooms.

### Class to Schedule:

Back to Back Courses—in general these course pairs are either scheduled completely or else are indicated as having missing instructors or missing classrooms. The first class in a pair of back-to-back classes sets the following flags for both classes:
   Same_Instructor_Flag (set implies use the same instructor(s) for both classes)
   Got_a_Instructor_Flag(set implies that have the instructor(s) for both classes)
   Got_a_room_Flag (set implies have the classrooms for both classes)
The first class in a pair of back-to-back classes sets the required date or date range.
The model's objective is to maximize the revenue/profit generated for all classes scheduled.
The model treats all classes as Public.
The city field may be specified as “ANY”. This allows the class to be scheduled in any city.

### The Solution Process

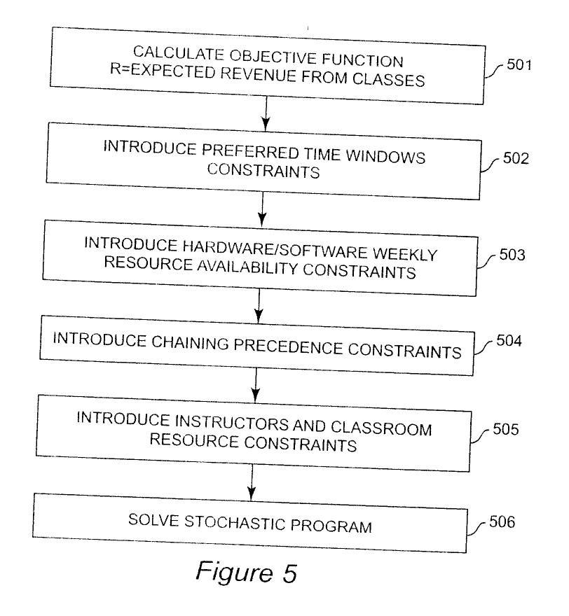

The process of creation and solution of a robust block scheduling model is shown in FIG. 5. The process begins at 501 by calculating an objective function R. In this case, the objective function R is the expected revenue from classes. At 502, preferred time windows constraints are introduced. Next, at 503, hardware/software weekly resource availability constraints are introduced. Then, at 504, chaining and precedence constraints are introduced. Finally, at 505, instructors and classrooms resource constraints are introduced. Once all the constraints have been introduced, the stochastic program is solved at 506.

The model formulation has the following additional characteristics captured in blocks 503 and 504 of FIG. 5:
(RESOURCE CONFLICTS) A set of classes should not run in the same week due to lab restrictions: e.g. classes of courses ZL100, ZV100, ZV050, ES680, ES170, QLX18—(segment 780). For example, required data for ABS-2 tool may be input as follows.
   # set of resources in a city—maybe just 1 important resource (lab HW) set RESOURCE[CHICAGO]:=780r1 780r2 780r3;
   # weekly capacities of the available resources (assumed to be static over the planning horizon)
param WEEKLY_CAPACITY:=
   780r1 2
   780r2 1
   780r3 2
   ;
   # the list of courses competing for an available resource (every week)—maybe generated dynamically
   # based on the resource requirements of the underlying courses (TA database)
   set COMPETING_COURSES[780r1]:=ZL100 ZV100 ZV050 ES680 ES170 QLX18;
   set COMPETING_COURSES [780r2]:=ES680 ES170 QLX18;
   set COMPETING_COURSES [780r3]:=ZL100 ZV050 ES680;
(CHAINING) Soft precedence among classes—Classes Q1313-1, Q1314-1, Q1316-1 should be offered in this sequence. The minimum spacing requirement (in weeks) between any two pair of predecessor-successor classes must be met. Note that these parameters
   (CHAINED_PREDECESSOR [ ] and MINIMUM_SPACE [ ]) essentially enforce an ordering among the classes that are ultimately scheduled by the ABS-2 tool; they do not capture the inter-dependence of the courses.
   # The list of classes preceding a candidate course
   set CHAINED_PREDECESSOR [Q1316-1]:=Q1314-1 Q1313-1;
   set CHAINED_PREDECESSOR [Q1314-1]:=Q1313-1;
   # Minimum spacing in weeks between a predecessor course and its successor
   param MINIMUM_SPACE:=
   Q1316-1 Q1314-1 3
   Q1316-1 Q1313-1 3
   Q1314-1 Q1313-1 3
(PRE-REQUISITES) Strict precedence among classes—(these do not have to be scheduled 1 week after the other, just in this order); e.g., ES050-1, ES150-1, ES10A-1, SS830-1, ES200-1, H3765-1, ES41A-1. Note that these parameters (CHAINED_PREDECESSOR [ ] and MINIMUM_SPACE [ ]) first specify an ordering preference among the classes to be scheduled; then the next parameter (PREREQ [ ]) specifies the inter-dependence of the classes to be scheduled.
   # The list of classes preceding a candidate class
   set CHAINED_PREDECESSOR [ES150-1]:=ES050-1;
   set CHAINED_PREDECESSOR [ES10A-1]:=ES150-1 ES050-1;
   set CHAINED_PREDECESSOR [SS830-1]:=ES10A-1 ES 150-1 ES050-1;
   set CHAINED_PREDECESSOR [ES200-1]:=SS830-1 ES10A-1 ES150-1 ES050-1;
   set CHAINED_PREDECESSOR [H3765-1]:=ES200-1 SS830-1 ES10A-1 ES150-1 ES050-1;
   set CHAINED_PREDECESSOR [ES41A-1]:=H3765-1 ES200-1 SS830-1 ES10A-1 ES150-1 ES050-1;
   # Minimum spacing in weeks between a predecessor class and its successor
   paran MINIMUM_SPACE:=
   ES150-1 ES050-1 1
   ES10A-1 ES150-1 1
   SS830-1 ES10A-1 1
   ES200-1 SS830-1 1
   H3765-1 ES200-1 1
   ES41A-1 H3765-1 1
   # Specify the inter-dependence—a course and its pre-requisite
   set PREREQ [ES150-1]:=ES050-1;
   set PREREQ [ES10A-1]:=ES150-1;
   set PREREQ [SS830-1]:=ES10A-1;
   set PREREQ [ES200-1]:=SS830-1;
   set PREREQ [H3765-1]:=ES200-1;
   set PREREQ [ES41A-1]:=H3765-1;
(ALL or NOTHING) Rigid dependence among classes—either all of the following classes A⇄B⇄C⇄D must be offered, or, none of these classes can be offered at all. In addition to the necessary spacing requirements among the classes, this “all_or_nothing” requirement may be captured by the following set of circular, pre-requisite descriptions:
   # Specify the inter-dependence—a class and its pre-requisite
   set PREREQ [D]:=C;
   set PREREQ [C]:=B;
   set PREREQ [B]:=A;
   set PREREQ [A]:=D;
(CANCELLATION PROBABILITY) Each requested class has a cancellation probability associated with it.
# Cancellation probability of class
   param CANCEL_PROB:=
   S6108-1 0.3
   Q1818-2 0.5

### Solution Approach

The computer implementation tool for the invention uses the probability distribution (a scenario tree) of realizable scenarios of quarterly class demands for each curriculum to build a robust class schedule by selecting a subset of all class requests to maximize expected profit/revenue. Each scenario is associated with a portfolio of classes, Lₛ, and a probability of the scenario's occurrence, pₛ, and the stochastic integer programming model's objective is to maximize the expected profit which is defined as the total expected revenue less the revenue shared with training partners and the operating costs of using resources (instructors and class rooms). A binary variable, o_{lwv} is used to describe the logical decision of scheduling class, l, in week, w, at location city, v; a binary variable, v_{lwv′d}, is used top describe the logical decision of starting the class, l, on day, d, of week, w, in location v′; binary variable, u_{rd′ld}, is used to describe the logical decision of using the room, r, on day, d′, for teaching class, l, that starts on day, d; binary variable, y_{lrd}, is used to describe the logical decision of using the room, r, for teaching class, l, that starts on day, d; binary variable z_{id′ld} is used to describe the logical decision of using the instructor, i, on day, d′, for teaching class, l, that starts on day, d; and binary variable, x_{lid}, is used to describe the logical decision of using the instructor, i, for teaching class, l, that starts on day, d.

With R_{lw} is the revenue from offering the class l in week w; CRᵣ and CIᵢ the per day costs of using a room r and instructor i, the objective for the stochastic integer program is to maximize the profit generated by offering an optimal subset of requested classes, which is set up as:

Maximize Σ_{lwvs}(R_{lw}o_{lwv}−Σ_{d,d′}CRᵣu_{rd′ld}−Σ_{d,d′}CIᵢz_{id′ld})×pₛ
Subject to:
(1) Class may or may not be offered, e.g.,

Σ_{wv}0_{lwv}≦1, for all l

Σ_{d}v_{lwv′d}=o_{lwv′}, for all l,w
(2) Restrict number of classes to be scheduled because of resource conflicts, e.g.,

Σ_{lεL(r)}o_{lwv≦N}ᵣ, for all w,v
(3) Each course can be offered at most once during a specified period p.
(4) Satisfy chaining (minimum n-weeks separation) and precedence requirements (not in the same week).
(5) Assign a room r to class l; assign TBD (to be determined) rooms if no room is allocated.
(6) Reserve assigned room r to class C for the entire duration of the course c.
(7) On any day d′ room r can hold at most one class C starting on day d.
(8) Assign instructors i to class l (handles multiple instructors as well).
(9) Reserve assigned instructors i to class l for the entire duration of the course c.
(10) On any day d′ instructor i can teach at most one class l starting on day d.
(11) Back-to-back Classes: (k, l) offered back-to-back in the same weeks if lengths allow; in consecutive weeks; otherwise,
(12) Back-to-back Classes: use same instructors if requested.
(13) Back-to-back Classes: use same rooms if requested.

With this model definition, the stochastic integer program may be input to a commercial solver using two approaches. One approach is to pass the above model to a standard commercial integer programming solver such as IBM's OSL or ELOG's CPLEX products. In our approach, we use this first approach in which we propose implementing the optimization model in a algebraic modeling language and then accessing OSL from this modeling environment to solve the stochastic program. An alternative approach may be to pass the model and data to a stochastic integer programming solver such as the IBM OSL Stochastic Extension product in which advanced algorithms exist for solving stochastic programs efficiently by exploiting the special structures underlying the scenario trees.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A stochastic integer programming based constrained optimization method for allocation of classrooms and instructors to requested classes associated with cancellation probabilities comprising the steps of:
inputting a list of classes, their cancellation probabilities and available classrooms and instructors;
analyzing operational revenue/profit under different planning scenarios involving chaining of various classes, prerequisite relationships, and inter-class spacing requirements; and
generating a revenue/profit optimization model of overall operational revenue/profit under the different planning scenarios.

2. A stochastic integer programming based constrained optimization method for allocation of classrooms and instructors to requested classes associated with cancellation probabilities comprising the steps of:
inputting a list of classes by location city, preferred time windows, their cancellation probabilities and available classrooms and instructors;
analyzing operational revenue/profit under different planning scenarios involving chaining of various classes, prerequisite relationships, and inter-class spacing requirements;
generating a revenue/profit optimization model of overall operational revenue/profit under the different planning scenarios by location city;
solving a stochastic program of a revenue/profit optimization model by solving its deterministic equivalent; and
outputting a list of classes scheduled by curriculum identification (ID), corresponding start date, allocated classrooms, location city, allocated instructor, and expected revenue.

3. The stochastic integer programming based constrained optimization method recited in claim 2, wherein the list of valid start dates for each class is calculated based on lengths of each class and available time windows for each class.

4. The stochastic integer programming based constrained optimization method recited in claim 3, wherein the lists of valid start dates for each back-to-back class is calculated based on lengths of each class and available time windows for each class.

5. The stochastic integer programming based constrained optimization method recited in claim 2, wherein the list of valid classrooms for each class is calculated based on tier codes for each class (course) and the available classrooms during the allowable time windows for each class.

6. The stochastic integer programming based constrained optimization method recited in claim 5, wherein the lists of classrooms for each back-to-back class is calculated based on lengths of each class and available time windows for each class.

7. The stochastic integer programming based constrained optimization method recited in claim 2, wherein the list of valid instructors for each class is calculated based on the available instructors with required skills during the allowable time windows for each class.

8. The stochastic integer programming based constrained optimization method recited in claim 7, wherein the lists of instructors for each back-to-back class is calculated based on lengths of each class and available time windows for each class.

9. The stochastic integer programming based constrained optimization method recited in claim 2, further comprising the steps of:
inputting a list of classes by location city, preferred time windows, their cancellation probabilities and available training partner (ATP);
generating a revenue/profit optimization model of overall operational revenue/profit under the different planning scenarios for all locations and training partner locations simultaneously; and
outputting a list of available training partner classes scheduled by curriculum ID, corresponding start date, and expected revenue.

10. The stochastic integer programming based constrained optimization method recited in claim 9, wherein the lists of valid start dates for each class is calculated based on lengths of each class and available time windows for each training partner (ATP) class.

11. The stochastic integer programming based constrained optimization method recited in claim 2, further comprising the steps of:
generating a revenue/profit optimization model of overall operational revenue/profit under the different planning scenarios for all locations simultaneously; and
outputting a distribution of optimal class schedules and associated revenue by scenario.

12. The stochastic integer programming based constrained optimization method recited in claim 2, wherein the cancellation probability for each class is calculated from historical data.

13. The stochastic integer programming based constrained optimization method recited in claim 2, further comprising the step of inputting a list of classes with pre-allocated start dates, classrooms and instructors.

14. A system implementing stochastic integer programming based constrained optimization for allocation of classrooms and instructors to requested classes associated with cancellation probabilities comprising:
a database of classes, instructors, classrooms and class requests;
a data processor accessing the database to input a list of classes, their cancellation probabilities and available classrooms and instructors; and
a stochastic integer programming module analyzing operational revenue/profit under different planning scenarios involving chaining of various classes, prerequisite relationships, and inter-class spacing requirements and generating a revenue/profit optimization model of overall operational revenue/profit under the different planning scenarios.
